(19) United States
(12) Patent Application Publication
(10) Pub. No.: US 2007/0294908 A1
(43) Pub. Date: Dec. 27, 2007

(54) System for washing driers with shelves

(75) Inventor: Paolo Debolini, Torino (IT)

Correspondence Address: SUGHRUE MION, PLLC, 2100 PENNSYLVANIA AVENUE, N.W., SUITE 800, WASHINGTON, DC, 20037, US

(73) Assignee: Paolo DEBOLINI

(21) Appl. No.: 11/471,664

(22) Filed: Jun. 21, 2006

(51) Int. Cl. F26B 19/00

(52) U.S. Cl. 34/90

(57) ABSTRACT

The washing system comprises an implement (60) which can be inserted in a drier (10) and which has a cleaning-liquid supply coupling (62), a distributor duct (64) which is supplied by the coupling (62), and a plurality of liquid-delivery ducts (66) which extend substantially transversely from the distributor duct (64) and carry respective spray heads (68) for the liquid at their ends. The drier (10) in turn comprises: a housing (12) which defines a drying chamber (14) in its interior and has a door (16) having a first opening (18) for the insertion of the supply coupling (62) of the washing implement (60) and a second opening (20) for the discharge of the cleaning liquid from the chamber (14), a shelving unit (26) located in the chamber (14) and having a plurality of shelves (28), and a circuit for the flow of a heating fluid, fixed firmly to the shelving unit (26) and having inlet and outlet ducts (32, 30) which extend through respective openings (34) formed through a fixed wall of the housing (12) and can be connected to respective heating-fluid supply and discharge pipes (40, 38).

The present invention relates to the field of systems for washing driers with shelves which are used in particular for drying chemical and pharmaceutical products.

A drier of this type typically comprises a housing which defines a drying chamber in its interior, a shelving unit located inside the chamber and having a plurality of shelves, and a circuit, fixed firmly to the shelving unit, for the flow of a fluid for heating the shelves.

Normal maintenance requires periodic careful washing of these driers. It is also obligatory to perform extremely careful washing upon a change in the type of products being dried. In fact it is essential to prevent mutual contamination of the products with unpredictable and dangerous effects, for example, in the event of the mixing of products which react with one another or of products of completely different natures, for example, substances that are harmful to man and food additives or drugs.

The object of the present invention is therefore to provide washing systems for driers with shelves which can operate effectively and economically in the various methods of use.

According to the invention, this object is achieved by means of washing implements, driers with shelves, and washing methods having the characteristics referred to specifically in the appended claims.

Advantages and characteristics of the present invention will become clear from the following detailed description which is provided by way of non-limiting example with reference to the appended drawings, in which:

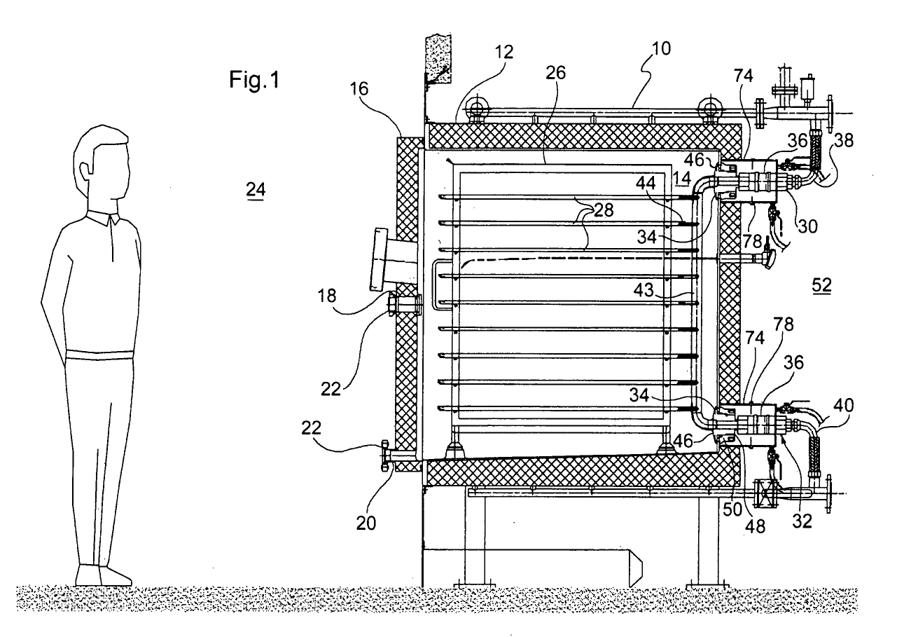

FIG. 1 is a schematic side elevational view of a drier of the invention in the configuration of normal operation,

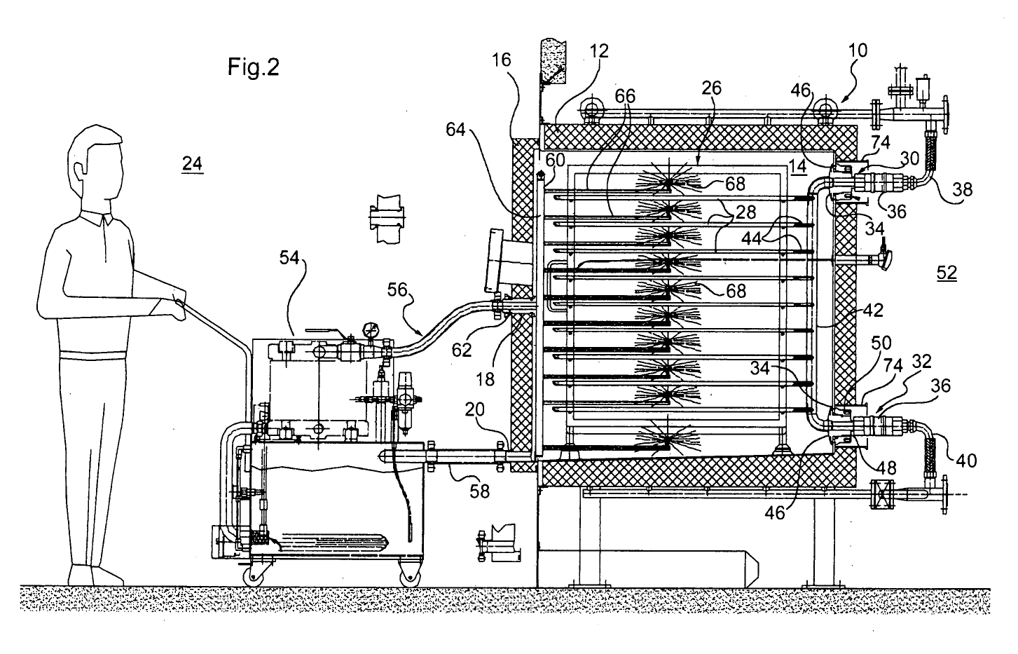

FIG. 2 is a schematic side elevational view of the drier of FIG. 1 during a normal maintenance washing procedure,

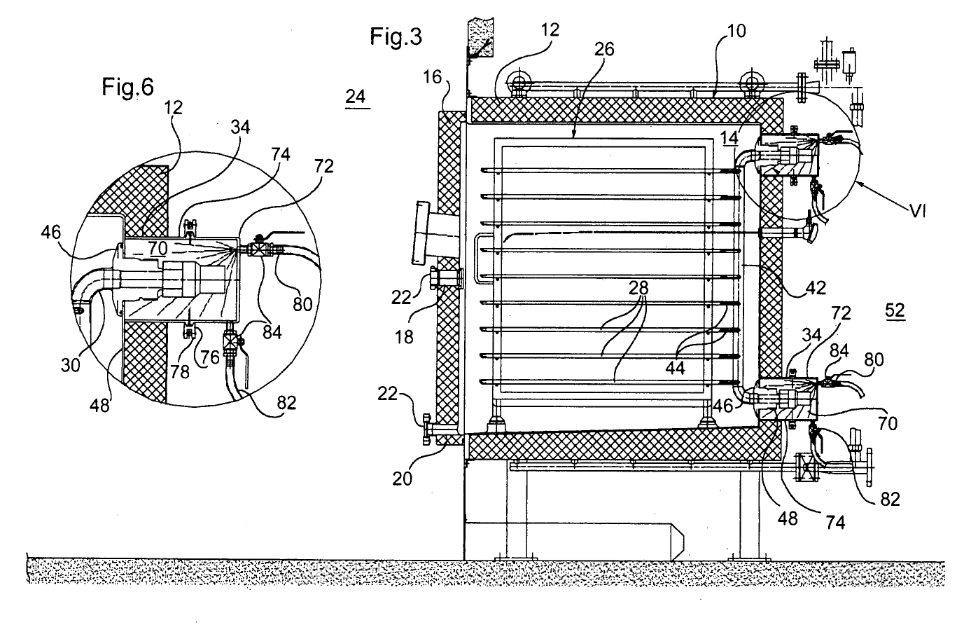

FIGS. 3 to 5 are schematic side elevational views of the drier of the previous drawings in successive stages of a thorough washing procedure, and

FIG. 6 is a view showing a detail of FIG. 3 on an enlarged scale.

A drier 10 comprises (FIG. 1) a housing 12 which defines a drying chamber 14 in its interior. The housing 12 comprises a door 16 having a first opening 18 and a second opening 20 which are closed by respective plugs 22 during normal operation. The door 16 opens into a sterile environment 24.

A removable shelving unit 26 is disposed in the chamber 14 and has a plurality of shelves 28 on which the products to be dried (which are not shown in the drawings for greater clarity) can be placed. Moreover, a circuit for the flow of a fluid for heating the shelves 28 is fixed firmly to the shelving unit 26. The circuit has an inlet duct 32 and an outlet duct 30 which extend through respective openings 34 formed through a fixed wall of the housing 12 and are connected to respective heating-fluid supply and discharge pipes 40 and 38 by quick coupling means 36. The heating circuit also comprises, in known manner, a manifold portion 42 and flow branches 44 formed within the various shelves 28.

Each of the inlet and outlet ducts 32, 30 has a radially projecting flange 46 and a portion having a threaded outer lateral surface 48 on which a ring-nut 50 having an internal threaded hole is engaged. The flange 46 and the ring-nut 50 can clamp between them a radially projecting annular portion of the edge of the respective opening 34 so as to isolate the interior of the chamber 14 from the working, that is non-sterile, environment 52 adjacent the openings 34 formed in the fixed wall of the housing 12.

The drier 10 described above is washed with the aid (FIG. 2) of a cleaning-liquid container-pressurizer device 54 having a delivery pipe 56 and a return pipe 58 for the cleaning liquid, and a washing implement 60 the methods of use of which will be described in greater detail in the following portion of this description. The device 54 is conventional whereas the implement 60 constitutes a subject of the present invention.

The implement 60 comprises a liquid-supply coupling 62, a distributor duct 64 which is supplied by the coupling, and a plurality of uniformly-spaced liquid-delivery ducts 66 which extend substantially transversely from the distributor duct 64 and carry spray heads 68 for the liquid at their respective distal ends. The supply coupling 62 is oriented substantially transversely relative to the distributor duct 64 and is located in the central portion thereof on the side remote from the delivery ducts 66. Advantageously, the number of delivery ducts 66 is equal to the number of shelves 28 of the drier 10 and the spacing of the ducts 66 is equivalent to that of the shelves 28.

A method for the normal maintenance washing of the above-described drier 10 provides first of all for the removal of the plugs 22 from the openings 18, 20 formed in the door 16. After the door 16 has been opened, the supply coupling 62 of the implement 60 can thus be inserted through the first opening 18 so that, after the closure of the door 16, the delivery ducts 66 of the implement 60 are interposed between the shelves 28.

The delivery pipe 56 of the cleaning-liquid container-pressurizer device 54 is then connected to the supply coupling 62 and the return pipe 58 of the device 56 is connected to the second opening 20 of the door 16.

Activation of the device 54 thus causes the cleaning liquid to be delivered into the chamber 14 through the spray heads 68 and the cleaning liquid is then discharged through the second opening 20. The liquid is then caused to flow back to the container-pressurizer device 54 through the return pipe 58 and, after optional purification, can then be sprayed into the chamber 14 again.

When the chamber 14 is considered to have been washed satisfactorily, the delivery of cleaning liquid is stopped and the delivery pipe 56 of the device 54 is disconnected from the supply coupling 62 and the return pipe 58 is disconnected from the second opening 20. Once the door 16 is open, the implement 60 can thus easily be removed from the interior of the chamber 14. Finally, after the plugs 22 have been replaced in the respective openings 18, 20, the washed drier 10 is ready to resume its normal operation.

In order to perform thorough washing of the drier 10, on the other hand, a different method is used which requires (FIGS. 3 and 6) the association with each of the openings 34 formed in the fixed wall of the housing 12 of means which can define a selectively sealable intermediate space 70 between the working environment 52 and the chamber 14. In particular, each of the selective sealing means takes the form of a cover 72 which can be fixed selectively to a bush 74, fixed firmly to the respective opening 34, by means of a pair of connectible flanges 76, 78 which constitute the facing surfaces of the cover 72 and of the bush 74, respectively. Each cover 72 is also provided with a supply duct 80 and a discharge duct 82 for the cleaning liquid. The ducts 80, 82 have respective on/off valves 84.

The thorough washing method provides first of all for the disconnection of the inlet duct 32 and the outlet duct 30 of the heating circuit from the respective heating-fluid supply and discharge pipes 40 and 38 (see FIG. 1) by operation of the respective quick-coupling means 36. The ring-nuts 50 are then unscrewed from the respective threaded portions 48 of the ducts 30, 32, separating the ring nuts 50 from the ducts 30, 32 which are thus released from any connection with the pipes 38, 40 and the housing 12.

The intermediate spaces 70 are then sealed by bolting together the flanges 76, 78 which constitute the respective facing surfaces of each cover/bush pair 72/74. It is thus possible to wash the intermediate spaces 70 as a result of a flow of cleaning liquid inside them through the supply and discharge ducts 80, 82, in which the respective on/off valves 84 are open.

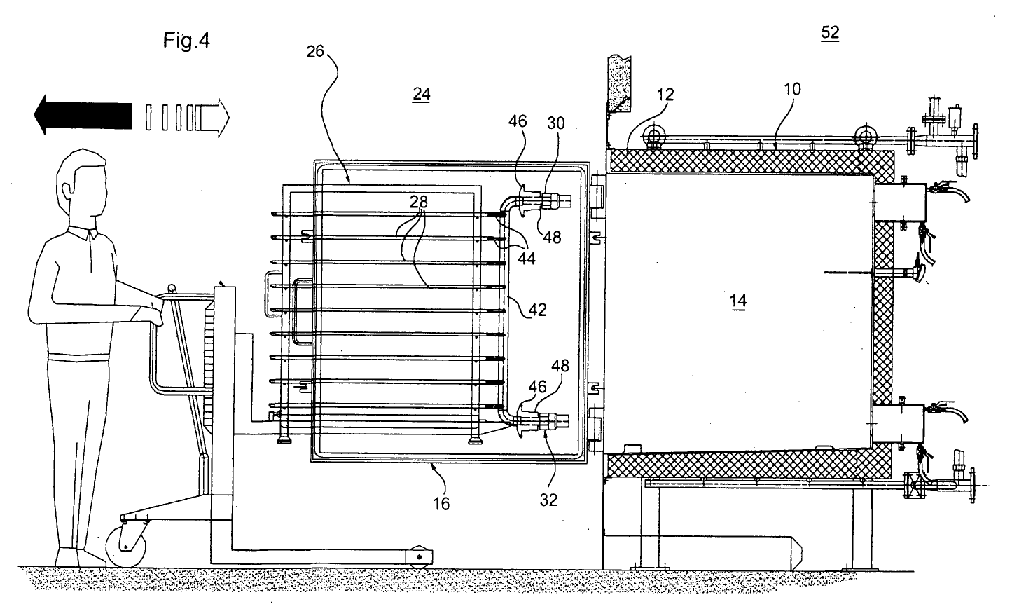

The subsequent removal (FIG. 4) of the shelving unit 26 from the chamber 14, which puts the intermediate spaces 70 into communication with the chamber 14, therefore creates no risk of contamination of the chamber by impurities which come from the working environment 52 and which have previously entered the spaces 70. As far as the shelving unit 26 is concerned, once it has been located outside the chamber 14, it is easily accessible and can be washed by any conventional device.

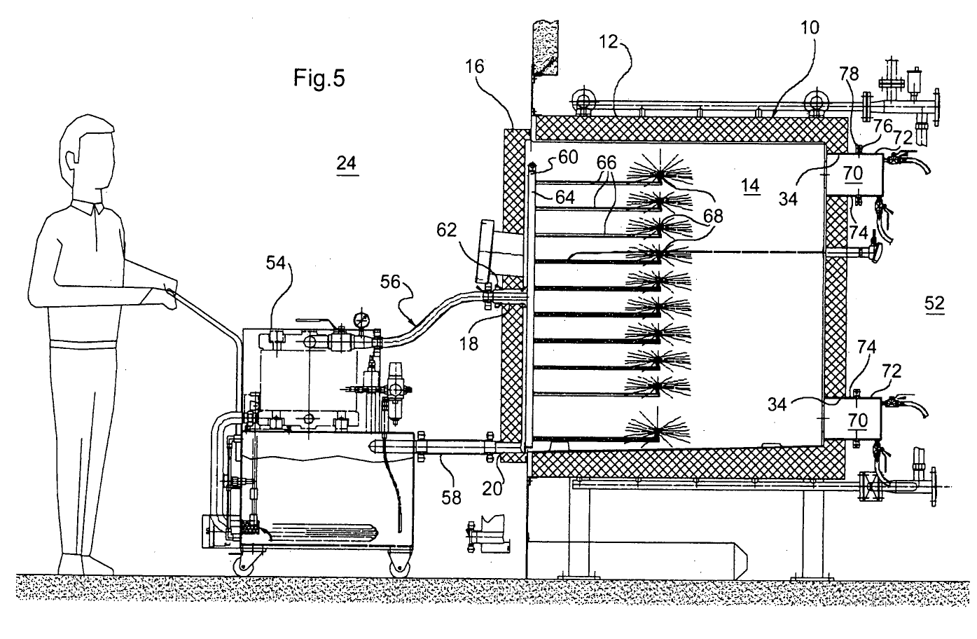

In parallel with the washing of the shelving unit 26, the plugs 22 are removed from the openings 18, 20 in the door 16, the supply coupling 62 of the implement 60 is inserted (FIG. 5) in the first opening 18, and the door 16 is closed so that the delivery ducts 66 of the implement 60 project into the chamber 14. As described with reference to the normal maintenance washing method, the delivery pipe 56 of the cleaning-liquid container-pressurizer device 54 is then connected to the supply coupling 62 and the return pipe 58 of the device 54 is connected to the second opening 20 of the door 16. Activation of the device 54 thus causes the cleaning liquid to be delivered into the chamber 14 through the spray heads 68 and the cleaning liquid is then discharged through the second opening 20. The liquid is then caused to flow back to the container-pressurizer device 54 through the return pipe 58 and, after optional purification, can be sprayed into the chamber 14 again.

When the chamber 14 is considered to have been washed satisfactorily, the delivery of cleaning liquid is stopped, the delivery pipe 56 of the cleaning-liquid container-pressurizer device 54 is disconnected from the supply coupling 62, and the return pipe 58 is disconnected from the second opening 20. Once the door 16 is open, the implement 60 can easily be removed from the interior of the chamber 14 in which the shelving unit 26 can be re-inserted.

At this point, the flanges 76, 78 which constitute the facing surfaces of each cover/bush 72/74 pair are disconnected, separating the covers 72 from the bushes 74 and putting the intermediate spaces 70 into communication with the working environment 52 but not with the chamber 14, from which they are isolated by the flanges 46 on the heating-fluid inlet and outlet ducts 30 and 32. The ring-nuts 50 are then screwed onto the respective threaded portions 48 of the ducts 32, 30 and the ducts are re-connected to the respective heating-fluid supply and discharge pipes 40, 38 by operation of the respective quick coupling means 36.

The thorough washing method is thus completed and the normal operating configuration of the drier 10 shown in FIG. 1 re-established.

Naturally, the principle of the invention remaining the same, the details of construction and forms of embodiment may vary widely with respect to the coupling described purely by way of example without thereby departing from its scope.

1. An implement (60) which can be inserted in a drier (10) with shelves (28) in order to wash the drier with a cleaning liquid, the implement (60) comprising a liquid-supply coupling (62), a distributor duct (64) which is supplied by the coupling (62), and a plurality of liquid-delivery ducts (66) which extend substantially transversely from the distributor duct (64) and carry respective spray heads (68) for the liquid at their ends.

2. An implement (60) according to claim 1 in which the delivery ducts (66) are uniformly spaced.

3. An implement (60) according to claim 1 in which the supply coupling (62) is oriented substantially transversely with respect to the distributor duct (64) and is located in the central portion thereof, on the side remote from the delivery ducts (66).

4. A drier (10) with shelves (28) in which a washing implement (60) according to claim 1 can be inserted, the drier comprising:
a housing (12) which defines a drying chamber (14) in its interior, the housing (12) comprising a door (16) having a first opening (18) for the insertion of the supply coupling (62) of the washing implement (60) and a second opening (20) for the discharge of the cleaning liquid from the chamber (14),
a shelving unit (26) located in the chamber (14) and having a plurality of shelves (28), and
a circuit, fixed firmly to the shelving unit (26), for the flow of a fluid for heating the shelves (28), the circuit having an inlet duct (32) and an outlet duct (30) which extend through respective openings (34) formed through a fixed wall of the housing (12) and can be connected to respective heating-fluid supply and discharge pipes (40, 38).

5. A drier (10) according to claim 4 in which each of the inlet and outlet ducts (32, 30) has a radially projecting flange (46) and a portion having a threaded outer lateral surface (48) with which a ring-nut (50) having an internal threaded hole is engaged, the flange (46) and the ring nut (50) being able to clamp between them a radially projecting annular portion of the edge of the respective opening (34).

6. A drier (10) according to claim 4 in which each of the openings (34) is provided with means which define a selectively sealable intermediate space (70) between the outside environment (52) and the chamber (14).

7. A drier (10) according to claim 6 in which the selective sealing means take the form of a cover (72) selectively fixable to a bush (74) fixed firmly to the opening (34), the cover (72) being provided with a supply duct (80) and a discharge duct (82) for the cleaning liquid.

8. A drier (10) according to claim 7 in which the supply and discharge ducts (80, 82) are provided with respective on/off valves (84).

9. A drier (10) according to claim 7 in which the facing surfaces of the cover (72) and of the bush (74) have respective flanges (76, 78) which can be coupled.

10. A method of washing a drier (10) according to claim 4 with an implement (60) which can be inserted in a drier (10) with shelves (28) in order to wash the drier with a cleaning liquid, the implement (60) comprising a liquid-supply coupling (62), a distributor duct (64) which is supplied by the coupling (62), and a plurality of liquid-delivery ducts (66) which extend substantially transversely from the distributor duct (64) and carry respective spray heads (68) for the liquid at their ends, the method comprising the steps of:
opening the door (16) of the housing (12), inserting the supply coupling (62) of the implement (60) in the first opening (18) of the door (16), and closing the door (16),
connecting a delivery pipe (56) of a cleaning-liquid container-pressurizer device (54) to the supply coupling (62) and a return pipe (58) of the device (54) to the second opening (20) of the door (16), so that the delivery ducts (66) of the implement (60) are interposed between the shelves (28) of the drier (10),
causing the cleaning liquid to be delivered into the chamber (14) through the spray heads (68), the cleaning liquid then being discharged from the chamber (14) through the second opening (20) and recirculated to the container-pressurizer device (54),
disconnecting the delivery pipe (56) of the cleaning-liquid container-pressurizer device (54) from the supply coupling (62) and the return pipe (58) of the device (54) from the second opening (20) of the door (16) of the housing (12), and
removing the implement (60) from the interior of the chamber (14).

11. A method of washing a drier (10) according to claim 6 with an implement (60) which can be inserted in a drier (10) with shelves (28) in order to wash the drier with a cleaning liquid, the implement (60) comprising a liquid-supply coupling (62), a distributor duct (64) which is supplied by the coupling (62), and a plurality of liquid-delivery ducts (66) which extend substantially transversely from the distributor duct (64) and carry respective spray heads (68) for the liquid at their ends, the method comprising the steps of:
disconnecting the inlet duct (32) and the outlet duct (30) of the heating circuit from the respective heating-fluid supply and discharge pipes (40, 38),
sealing intermediate spaces (70) interposed between the outside environment (52) and the chamber (14) in the region of the openings (34) formed in a fixed wall of the housing (12),
washing the intermediate spaces (70) with the cleaning liquid,
opening the door of the housing (16) and removing the shelving unit (26) from the chamber (14), putting the washed intermediate spaces (70) into communication with the chamber (14),
washing the shelving unit (26) outside the chamber (14),
inserting the supply coupling (62) of the implement (60) in the first opening (18) of the door (16) of the housing (12) and closing the door (16) of the housing (12),
connecting the delivery pipe (56) of the container-pressurizer device (54) to the supply coupling (62) and the return pipe (58) of the device (54) to the second opening (20) of the door (16) of the housing (12),
causing the cleaning liquid to be delivered into the chamber (14) through the spray heads (68), the cleaning liquid being discharged through the second opening (20) and recirculated to the container-pressurizer device (54),
disconnecting the delivery pipe (56) of the cleaning-liquid container-pressurizer device (54) from the supply coupling (62) and the return pipe (58) of the device (54) from the second opening (20) of the door (16) of the housing (12),
opening the door (16) of the housing (12) and removing the implement (60) from the interior of the chamber (14),
re-inserting the shelving unit (26) in the chamber (14) and closing the door (16),
unsealing the intermediate spaces (70) relative to the outside environment (52), and
connecting the inlet and outlet ducts (32 and 30) of the heating circuit to the respective heating-fluid supply and discharge pipes (40, 38).
